(19) United States
(12) Patent Application Publication
(10) Pub. No.: US 2004/0108629 A1
(43) Pub. Date: Jun. 10, 2004

(54) Method for fabricating ceramic substrate

(75) Inventors: Yoshihiko Imanaka, Kawasaki (JP); Masatoshi Takenouchi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 10/724,615

(22) Filed: Dec. 2, 2003

(30) Foreign Application Priority Data
Dec. 3, 2002 (JP) 2002-351133

(51) Int. Cl. B28B 1/00

(52) U.S. Cl. 264/614; 264/642; 264/650

(57) ABSTRACT

The method for fabricating a ceramic substrate comprises the step of screen-printing a first dielectric material in a first region of a resin film 30 and screen-printing a second dielectric material of a dielectric constant different from that of the first dielectric material in a second region of the resin film 30 to form a layer including on the resin film 30 a high dielectric layer 20a of the first dielectric material and a base dielectric layer 24a of the second dielectric material, the step of releasing the layer from the resin film 30, and the step of sintering the layer released form the resin film 30.

### CROSS-REFERENCE TO RERATED APPLICATION

This application is based upon and claims priority of Japanese Patent Application No. 2002-351133, filed on December 3, 2002, the contents being incorporated herein by reference.

### BACKGROUND OF THE INVENTION

The present invention relates to a method for fabricating a ceramic substrate, more specifically a method for fabricating a ceramic substrate incorporating a passive function.

Mobile instruments represented by cellular phones, wireless information communication with Bluetooth, wireless LAN (Local Area Network), etc. have been required to transmit large volumes of data signals of audio data, video data, etc.

On the other hand, mobile terminal instruments for realizing the high speed transmission of such large volumes of data signals are rapidly and increasingly smaller-sized and have more multiple functions and higher performances.

As means of smaller-sizing such terminal instruments, higher-density mounting techniques, and module integration of passive elements, such as antennas, filters, etc., in radio-frequency circuits are used. As techniques for such module integration, many means have been proposed. Among these techniques, especially the technique of using LTCC (Low Temperature Cofired Ceramic) process to integrate in a module an antenna layer, a filter layer, a condenser layer, etc. is becoming dominant because of the merit that the technique has low costs, and other merits.

For further small-sizing the module, the followings are being studied from various viewpoints.

From the viewpoint of the material development, for example, high dielectric materials are developed for small-sizing the module. The wavelength of transmission electromagnetic waves is proportional to the inverse of the square root of the dielectric constant of a transmitter material. As the dielectric constant of a transmitter material is higher, the wavelength of the transmission electromagnetic wave is shorter. Resultantly, the module can be small-sized.

From the viewpoint of the structure and process development, for small-sizing the module substrate, the process of incorporating a multi-layer structure of layers of different dielectric constants in a ceramic substrate for further integration is developed.

In order to make the best use of the results of the material development and the process development in making products so as to realize the small-sized module, it is necessary to strictly control the alignment accuracy for interconnection patterns of the respective layers.

As a method of small-sizing the module substrate, various attempts to use different materials in the layers of a multi-layer structure to thereby form passive elements, and incorporate surface mounted devices, etc., such as capacitors, etc., inside ceramic substrates are made (refer to, e.g., Japanese Patent Application Unexamined Publication No. Hei 7-86747 (1995), Japanese Patent Application Unexamined Publication No. Hei 8-32242 (1996) and Japanese Patent Application Unexamined Publication No. Hei 9-92983 (1997)).

For example, the method of stacking ceramic green sheets of different material compositions and sintering at one and the same temperature the sheets integral is known. FIGS. 7A and 7B are diagrammatic views of the structure of the module substrate formed by this method. FIG. 7A is a sectional view of the module substrate, which shows the structure thereof. FIG. 7B is a perspective view of the module substrate, which shows the respective layers.

As shown in FIGS. 7A and 7B, green sheets 100a, 100b, 100c, 102a, 102b, 103a, 103b, 103c, 102c of different materials having conductor patterns formed on the surfaces which are to be the interconnections and the electrodes are laid the latter on the former in the sated order and are sintered integral at one temperature. The green sheets 100a, 100b, 100c, the green sheets 102a, 102b, 102c, and the green sheets 103s, 103b, 103c have dielectric constants different from one another. As shown in FIG. 7A, vias 104 are formed in the stacked green sheets to electrically interconnect the conduct layers 106 of the electrodes, interconnections, etc. of the respective green sheets. Inside the substrate, passive elements, such as capacitors, etc., of the green sheets of different materials sandwiched by the electrodes are formed.

The method of forming holes in each of the green sheets forming the multi-layer structure and burying different materials in the holes to form passive elements in the x and the y directions of the green sheet, whereby the passive element is incorporated inside a substrate, is also known. FIGS. 8A and 8B are diagrammatic views of a structure of the module substrate formed by such method. FIG. 8A is a sectional view of the module substrate, which shows the structure thereof. FIG. 8B is a perspective view of the module substrate, which shows the respective layers.

As shown in FIGS. 8A and 8B, the green sheets 108a, 108b, 108c, 10d having conductor patterns formed on the surfaces which are to be the interconnections and the electrodes are stacked and sintered integral. Holes are formed in the green sheets 108b, 108c, and passive elements 110 are formed of different materials buried in the holes. Stress mitigating layers 111 for mitigating stresses exerted between the passive elements 110 and the green sheets 108b, 108c are formed on the side walls of the holes with the passive elements 110 buried in. Vias 112 are formed in the respective green sheets 108a, 108b, 108c, 108d, and through the vias 112, the electrodes, the interconnections, etc. of the respective green sheets 108a, 108b, 108c, 108d are electrically interconnected.

### SUMMARY OF THE INVENTION

However, in the substrate shown in FIGS. 7A and 7B, which comprises ceramic green sheets of different material compositions stacked and sintered integral at one and the same temperature, the respective materials have different sintering shrinkage rates and shrinking manners. Resultantly, a disadvantage that releases tend to take place between the layers sintered integral will be considered.

In the substrate shown in FIGS. 7A and 7B, which comprises green sheets of different materials stacked, the materials having different characteristics run through stacked layers, which will make the electric signal characteristics unstable. The transmission circuits of the low dielectric layers, and the circuits of the high dielectric layers, such as capacitors, filters, etc., are formed in the layers. Depending on the circuit design, the transmission circuits will bridge the high dielectric layers. Resultantly, impedance unmatching will take place. Furthermore, the passive elements are formed of the layer of different materials. Accordingly, the interconnections must be led out to the part of the different materials. Thus, it can be said that in comparison with forming SMDs (Surface Mounted Devices) on a substrate surface, the incorporation of the passive elements does not always lead to the shortening the interconnection routes. Furthermore, the different materials functioning as the passive elements are provided in the layers. Accordingly, even when small passive elements are provided, one layer of a different material is required. This is a restriction to the extent of small-sizing.

In the substrate shown in FIGS. 8A and 8B, in which holes are formed in the stacked green sheet, and different materials are buried in the holes to thereby incorporate passive elements, stresses due to disuniform shrinking rates take place in the interfaces between the different material buried portions and the base materials. Resultantly, the substrate has disadvantages of cracks, poor inter-layer adhesion, etc.

All of the above-described conventional ceramic substrates use green sheets. The use of the green sheets will cause the following disadvantages in realizing smaller-sizing the module substrate. When green sheets are stacked, the green sheets must be aligned with each other and stacked to be integrated. However, it is known that green sheets change their sizes during being stored after formed or when handled. Accordingly, it is considered difficult to hinder displacement between the stacked green sheets by 1/10 percentages.

When high dielectric materials are used, as outer dimensions are smaller, the interconnection dimensions are smaller. Therefore the alignment with higher precision is required. Thus, smaller-sizing the module substrate by the conventional method using the green sheets having the property that they change their sizes during being stored after formed or when handled will be restricted.

An object of the present invention is to provide a method for fabricating a ceramic substrate, which can align layers with high precision and can introduce in plane with high reliability different materials which are to form passive elements.

According to one aspect of the present invention, there is provided a method for fabricating a ceramic substrate comprising the steps of: forming a basic layer by screen-printing a first dielectric material in a first region of a base and screen-printing a second dielectric material of a dielectric constant different from a dielectric constant of the first dielectric material in a second region of the base, the basic layer including a first dielectric layer of the first dielectric material and a second dielectric layer of the second dielectric material; releasing the basic layer from the base; and sintering the basic layer released from the base. The use of screen printing makes it possible to form with high alignment precision by printing the first dielectric layer and the second dielectric layer. Accordingly, the substrate can be formed without being influenced by dimensional changes of materials, whereby different materials can be introduced in the substrate with high precision and high reliability.

In the above-described method, it is possible that the step of forming the basic layer further includes the step of screen-printing a third dielectric material in a third region of the base at a periphery of the first region to form a third dielectric layer for mitigating stress generated between the first dielectric layer and the second dielectric layer. By forming the third dielectric layer, stresses due to the shrinkage rate difference between the different materials can be mitigated, and the generation of cracks and inter-layer release can be suppressed. Accordingly, a ceramic substrate of high reliability and good characteristics can be formed.

As described above, according to the present invention, a first dielectric material is screen-printed in a first region of a base, and a second dielectric material of a dielectric constant different from a dielectric constant of the first dielectric material is screen-printed in a second region of the base to form a basic layer including a first dielectric layer of the first dielectric material and a second dielectric layer of the second dielectric material; the basic layer is released from the base; and the basic layer released from the base is sintered, whereby the inter-layer alignment of the ceramic substrate can be made with high precision, and different materials to form passive elements can be introduced in plane with high reliability.

### BRIEF DESCRIPTION OF THE DRAWINGS

FIG. 1 is a sectional view of a ceramic substrate formed by the method for fabricating a ceramic substrate according to one embodiment of the present invention.

FIGS. 2A-2D are sectional views of the ceramic substrate in the steps of the method for fabricating a ceramic substrate according to the embodiment of the present invention, which show the method (Part 1).

FIGS. 3A-3C are sectional views of the ceramic substrate in the steps of the method for fabricating a ceramic substrate according to the embodiment of the present invention, which show the method (Part 2).

FIGS. 4A-4C are sectional views of the ceramic substrate in the steps of the method for fabricating a ceramic substrate according to the embodiment of the present invention, which show the method (Part 3).

FIGS. 5A-5C are sectional views of the ceramic substrate in the steps of the method for fabricating a ceramic substrate according to the embodiment of the present invention, which show the method (Part 4).

FIGS. 6A-6C are sectional views of the ceramic substrate in the steps of the method for fabricating a ceramic substrate according to the embodiment of the present invention, which show the method (Part 5).

FIGS. 7A-7B are diagrammatic views of the conventional ceramic substrate, which show the structure thereof.

FIGS. 8A-8B are diagrammatic views of the conventional ceramic substrate, which show the structure thereof.

### DETAILED DESCRIPTION OF THE INVENTION

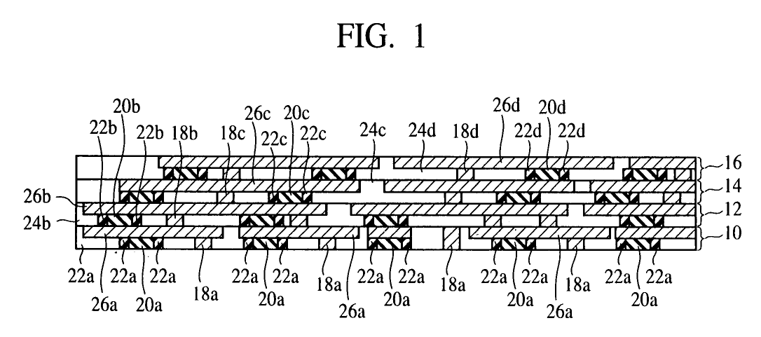

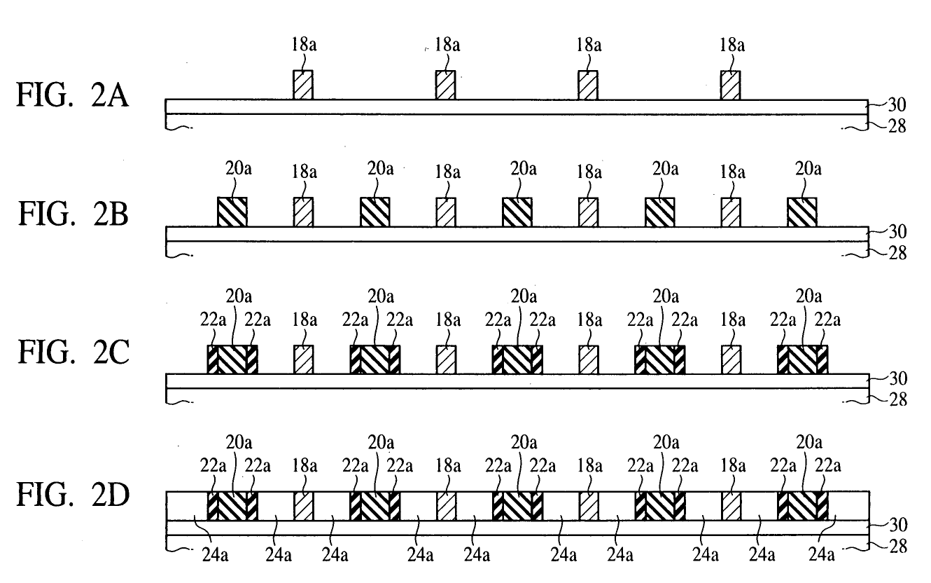

The method for fabricating a ceramic substrate according to one embodiment of the present invention will be explained with reference to FIGS. 1, 2A-2D, 3A-3C, 4A-4C, 5A-5C and 6A-6C. FIG. 1 is a sectional view of the ceramic substrate to be formed by the method for fabricating a ceramic substrate according to the present embodiment, which shows the structure thereof. FIGS. 2A-2D, 3A-3C, 4A-4C, 5A-5C and 6A-6C are sectional views of the ceramic substrate in the steps of the method for fabricating a ceramic substrate according to the present embodiment, which show the method.

First, the ceramic substrate to be formed by the method for fabricating a ceramic substrate according to the present embodiment will be explained with reference to FIG. 1. In FIG. 1, the ceramic substrate has the four-layer structure of a first layer 10, a second layer 12, a third layer 14 and a fourth layer 16.

Vias 18a of a metal, and a high dielectric layers 20a of a high dielectric material which forms passive elements, etc. are formed in the first layer 10 at prescribed positions. Stress mitigating layers 22a of a dielectric material are formed at the peripheries of the high dielectric layers 20a. A base dielectric layer 24a of a dielectric material is formed in the regions of the first layer 10, where the vias 18a, the high dielectric layers 20a and the stress mitigating layers 22a are not formed. A conductor layer 26a electrically connected to prescribed vias 18a and prescribed high dielectric layers 20a and having patterns of interconnections and electrodes is formed in the first layer 10 at prescribed upper part thereof. The first layer 10 is thus formed.

Vias 18b of a metal electrically connected to the conductor layer 26a in the upper part of the first layer 10, and high dielectric layers 20b of of a high dielectric material forming passive elements, etc. are formed in the second layer 12 on the first layer 10. Stress mitigating layers 22b of a dielectric material are formed at the peripheries of the high dielectric layers 20b, as in the first layer 10. A base dielectric layer 24b is formed in the regions of the second layer 12, where the vias 18b, the high dielectric layers 20b and the stress mitigating layers 22b are not formed. A conductor layer 26b electrically connected to the prescribed vias 18b and the high dielectric layers 20b and having patterns of interconnections and electrodes is formed in the second layer 12 at upper part thereof.

As in the first layer 10 and the second layer 12, vias 18c, 18d, high dielectric layers 20c, 30d, stress mitigating layers 22c, 22d, base dielectric layers 24c, 24d and conductor layer 26c, 26d are formed in the third layer 14 on the second layer 12, and in the fourth layer 16 on the third layer 14.

Circuits formed of the high dielectric layers and conductor layers of the respective layers described above have the functions of, e.g., transmission interconnection circuits, antennas, low-pass filters, high-pass filters, band-pass filters, capacitors, etc. For example, on and below the respective high dielectric layers, electrodes are formed of the conductor layers, forming these passive elements. The ceramic substrate formed by the method for fabricating a ceramic substrate according to the present embodiment is applicable to, e.g., circuit modules for radio-frequency electromagnetic waves of above 1 GHz.

The ceramic substrate comprising of the first to the fourth layers, which is formed by the method for fabricating a ceramic substrate according to the present embodiment is thus constituted.

The method for fabricating a ceramic substrate according to the present embodiment is characterized mainly in that the ceramic substrate of the above-described multi-layer structure is formed by screen printing.

The use of screen printing makes it possible to form with high alignment precision by printing the vias 18a, 18b, 18c, 18d, the high dielectric layers 20a, 20b, 20c, 20d, the stress mitigating layers 22a, 22b, 22c, 22d, the base dielectric layers 24a, 24b, 24c, 24d and the conductor layers 26a, 26b, 26c, 26d included in the respective layers. The substrate can be formed without the necessity of using green sheets, which can easily change their dimensions during stored and in other occasions and without being influenced by dimensional changes of materials, and accordingly different materials functioning as the passive elements, etc. can be introduced in the substrate with high precision and high reliability. The substrate can be formed without being influenced by dimensional changes of materials, and furthermore, screen printing can print printing materials with high alignment precision. Accordingly, the alignment among the layers forming the multiple-layer substrate can be made with high precision.

The method for fabricating a ceramic substrate according to the present embodiment will be explained below with reference to FIGS. 2A-2D, 3A-3C, 4A-4C, 5A-5C and 6A-6C.

First, the materials to be printed by screen printing to form the respective layers will be explained.

The high dielectric material for forming the high dielectric layers 20a, 20b, 20c, 20d can be prepared in, e.g., the following way.

First, 20 vol % of TiO₂ powder of a 5 μm average particle diameter and 80 vol % of silicic acid-based glass power which will deposit NdTiO₃ crystals of a 3 μm average particle diameter are mixed, and the mixed powder of them is prepared.

Next, 8 wt % of poly(vinyl butyral) (PVB) resin as a binder and 3 wt % of dibutyl phthalate (DBP) as a plasticizer are added to the prepared mixed powder. Acetone is further added as a solvent. Then, the mixed powder is agitated for 20 hours with a ball mill, and a slurry is prepared.

Next, the milled slurry is formed into paste by a smash mixing machine while the acetone solvent is being evaporated, and a terpineol is being added.

Next, the prepared paste is agitated and dispersed with a three-roll mill.

The high dielectric material paste for forming the high dielectric layer 20a, 20b, 20c and 20d is thus prepared. The viscosity of the thus-prepared high dielectric material paste is, e.g., 300 Pa.s (3,000 poise).

The dielectric material for the stress mitigating layers to form the stress mitigating layers 22a, 22b, 22c, 22d can be formed in, e.g., the following way.

First, 20 vol % of alumina powder of a 3 μm average particle diameter, 20 vol % of TiO₂ powder of a 2 μm average particle diameter, and 60 vol % of borosilicic acid-based glass powder which will deposit MgCaSiO₄ crystals of a 3 μm average particle diameter are mixed, and the mixed power of them is prepared.

Next, 5 wt % of PVB resin as a binder and 1 wt % of DBP as a plasticizer are added to the prepared mixed powder. Acetone is further added as a solvent. Then, the mixed powder is agitated for 20 hours with a ball mill, and a slurry is prepared.

Next, the milled slurry is formed into paste by a smash mixing machine while the acetone solvent is being evaporated, and terpineol is being added.

Next, the prepared paste is agitated and dispersed with a three-roll mill.

The dielectric material paste for the stress mitigating layers to form the stress mitigating layers 22a, 22b, 22c, 22d is thus prepared. The viscosity of the thus-prepared dielectric material paste for the stress mitigating layers is, e.g., 250 Pa.s (2,500 poise).

The base material for forming the base dielectric layers 24a, 24b, 24c, 24d can be prepared in, e.g., the following way.

First, 30 vol % of alumina powder of a 2 μm average particle diameter and 70 vol % of borosilicic acid-based glass powder which will deposit MgCaSiO₄ crystals of a 3 μm average particle diameter are mixed, and the mixed power of them is prepared.

Next, 5 wt % of PVB resin as a binder and 2 wt % of DBP as a plasticizer are added to the prepared mixed powder. Acetone is further added as a solvent. Then, the mixed powder is agitated for 20 hours with a ball mill, and a slurry is prepared.

Next, the milled slurry is formed into paste by a smash mixing machine while the acetone solvent is being evaporated, and terpineol is being added.

Next, the prepared paste is agitated and dispersed with a three-roll mill.

Next, the prepared paste is agitated and dispersed with a three-roll mill.

The base material paste for forming the base dielectric layers 24a, 24b, 24c, 24d is thus prepared. The viscosity of the thus-prepared base material paste is, e.g., 3000 Pa.s (3,000 poise).

Next, the respective steps of the method for fabricating a ceramic substrate according to the present embodiment will be explained.

First, Ag paste, for example is printed in poles on a resin film 30 on a substrate 28 as the printing based at prescribed positions by screen printing. Then, the Ag paste printed on the resin film 30 is dried by heat treatment of, e.g., 80°C. Thus, pole-shaped vias 18a of Ag are formed on the resin film 30 at the prescribed positions (see FIG. 2A). In printing the Ag paste by screen printing it is noted that the viscosity of the Ag paste is adjusted so that the vias 18a can have a prescribed height and configurations.

Then, the high dielectric material is printed on the resin film 30 at prescribed positions. Then, the high dielectric material printed on the resin film 30 is dried. Thus, the high dielectric layers 20a before sintered of the high dielectric material are formed on the resin film 30 at prescribed positions (see FIG. 2B).

Next, the dielectric material for the stress mitigating layer to be the stress mitigating layers 22a is printed by screen printing on the resin film 30 at the peripheries of the high dielectric layers 20a. Next, the printed dielectric material for stress mitigating layer is dried by heat treatment of, e.g., 80° C. Thus, the stress mitigating layers 22a before sintered of the dielectric material for stress mitigating layer are formed at the peripheries of the high dielectric layers 20a (see FIG. 2C).

The stress mitigating layers 22a formed at the peripheries of the high dielectric layers 20a have a material composition which is middle between the material composition of the high dielectric layer 20a and that of the base dielectric layer 24a which will be formed later, whereby stresses due to the shrinkage rate difference between the different materials can be mitigated, and the generation of cracks and inter-layer release can be suppressed. Accordingly, a ceramic substrate of high reliability and good characteristics can be formed.

Then, the base material to be the base dielectric layer 24a is printed by screen printing in the regions of the resin film 30, which have not been printed yet. Then, the printed base material is dried by heat treatment of, e.g., 80° C. Thus, the base dielectric layer 24a before sintered of the base material is formed in the regions of the resin film 30 which have not been printed yet, and the vias 18a, the high dielectric layer 20a and the stress mitigating layer 22a are buried in the base dielectric layer 24a (see FIG. 2C).

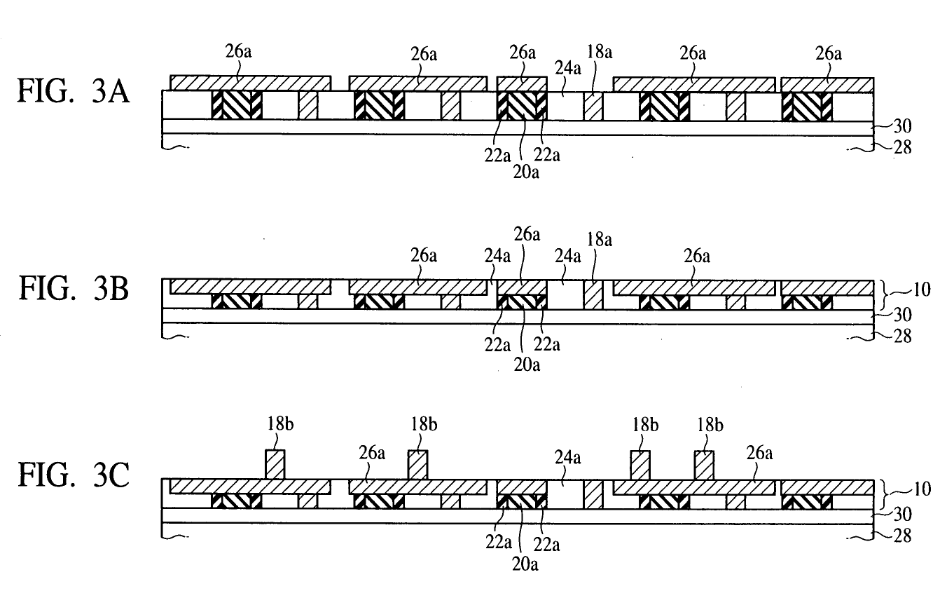

Next, on the layer formed of the printed vias 18a, high dielectric layer 20a, stress mitigating layer 22a and the base dielectric layer 24a, Ag paste is printed in prescribed interconnection patterns and electrode patterns by screen printing. Next, the printed Ag paste is dried by heat treatment of, e.g., 80° C. Thus, the conductor layer 26a having the prescribed interconnection patterns and electrode patterns and formed of Ag is formed (see FIG. 3A).

Then, a 2-20 kgf/cm² pressure is applied to the layer thus formed by screen printing as described above at the surface where the conductor layer 26a is formed. This pressurization compresses the layer into prescribed thicknesses, and the conductor layer 26a printed in convexities on the layer formed of the high dielectric layer 20a, the stress mitigating layer 22a and the base dielectric layer 24a is buried in the base dielectric layer 24a, etc. The surface on which the conductor layer 26a has been formed is planarized (see FIG. 3B). This planarization can reduce warps of the multi-layer substrate comprising a plurality of layers.

Thus, the first layer 10 of the ceramic substrate before sintered is formed.

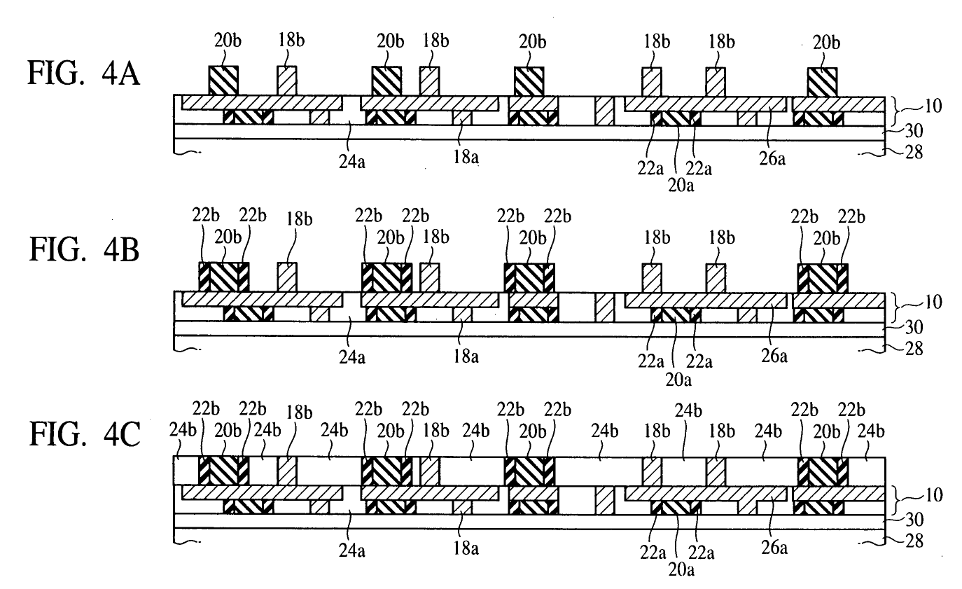

Then, for the second layer 12, in the same way as in forming the first layer 10, the vias 18b, the high dielectric layer 20b, the stress mitigating layer 22b and the base dielectric layer 24b are formed sequentially on the first layer 10 by screen printing (see FIG. 3C and FIGS. 4A-4C). Then, in the same way as in forming the first layer 10, Ag paste is printed by screen printing to form the conductor layer 26b, and then the layer structure is pressurized under a prescribed pressure. Thus, the second layer 12 of the ceramic substrate before sintered is formed on the first layer 10.

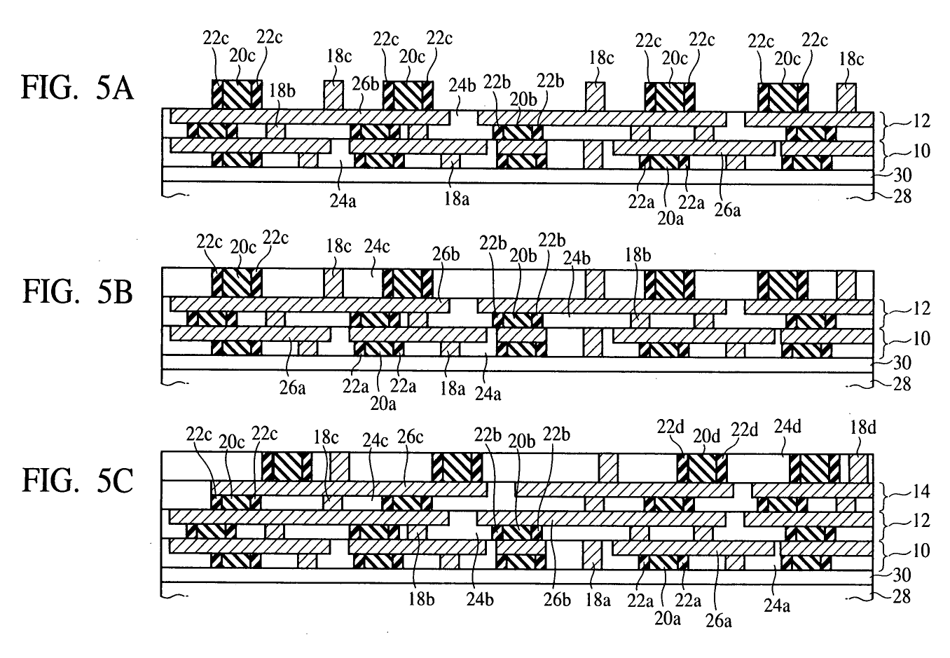

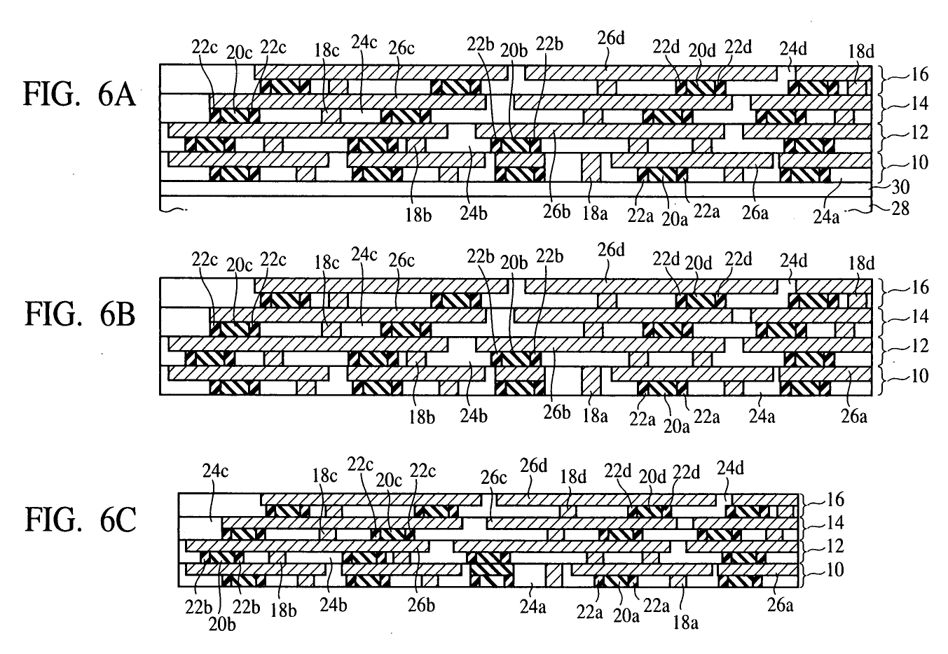

Next, in the same way as in forming the first layer and the second layer 12, the third layer 14 and the fourth layer 16 are sequentially formed by screen printing (see FIGS. 5A-5C and 6A).

The electrode parts of the conductor layers of the respective layers are formed, vertically sandwiching the high dielectric layers of the respective layers, whereby the passive elements, such as the capacitors, the various filters, etc., are formed inside the substrate.

As described above, the ceramic substrate before sintered comprising the first to the fourth layers is formed on the resin film 30 by screen printing (see FIG. 5A).

Next, the ceramic substrate before sintered is released form the resin film 30 (see FIG. 6B).

Next, the ceramic substrate released from the resin film 30 is sintered in the air to be integrated (see FIG. 6C). Conditions for the sinter can be, e.g., a 900° C. sintering temperature and 2 hours of sintering. Other wise, the sintering temperature may be, e.g., 80° C. and 30 minutes of sintering under pressure.

As described above, the ceramic substrate shown in FIG. 1 according to the present embodiment, which comprises the first to the fourth layers can be formed.

As described above, according to the present embodiment, the vias 18a, 18b, 18c, 18d, the high dielectric layers 20a, 20b, 20c, 20d, the stress mitigating layers 22a, 22b, 22c, 22d, the base dielectric layers 24a. 24b, 24c, 24d and the conductor layers 26a, 26b, 26c, 26d which form the respective layers of the ceramic substrate, are formed by screen printing, whereby different materials which function as passive elements, etc. can be introduced in the substrate with high precision and reliability, and the inter-layer alignment of the layers forming the multi-layer substrate can be made with high precision.

The stress mitigating layers 22a, 22b, 22c, 22d having a material composition which is middle between a material composition of the high dielectric layers 20a, 20b, 20c, 20d and that of the base dielectric layers 24a, 24b, 24c, 24d are formed at the peripheries of the high dielectric layers 20a, 20b, 20c, 20d, whereby stresses due to shrinking rate differences between the different materials can be mitigated, and the generation of cracks and inter-layer releases can be suppressed. Accordingly, the ceramic substrate thus formed can have high reliability.

(Evaluation Result)

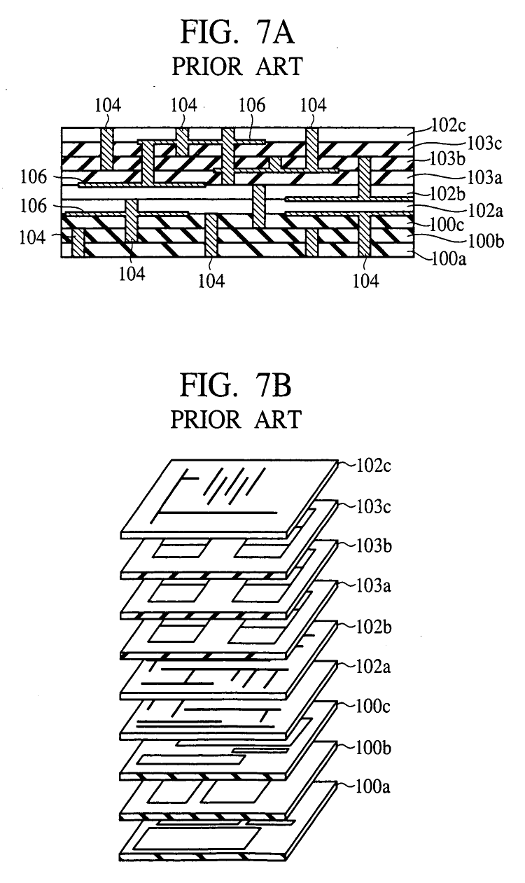

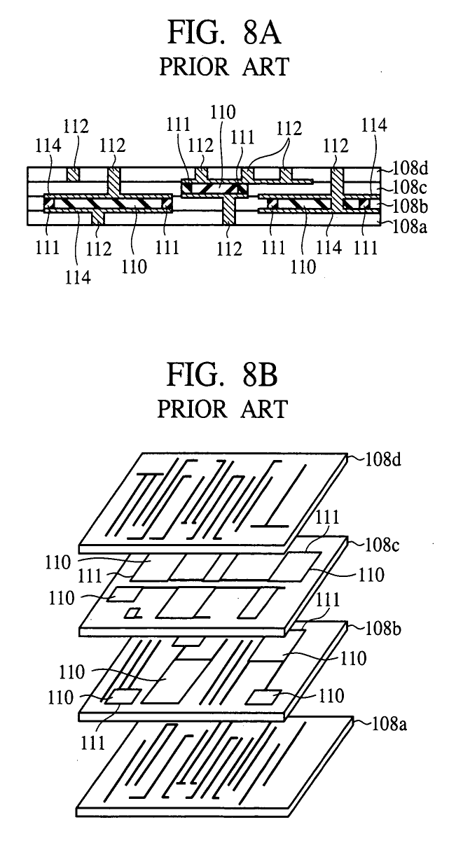

An RF module for Bluetooth formed by the method for fabricating a ceramic substrate according to the present invention, and RF modules formed by the conventional techniques were compared in the alignment precision, reliability, etc. The following TABLE 1 shows the comparison result. In TABLE 1, Control 1 which was compared with an Example of the present invention in the alignment precision, etc. is a substrate which does not incorporate the passive functions inside it. Control 2 is a substrate prepared by the conventional method shown in FIGS. 7A and 7B, in which ceramic green sheets of different material compositions are stacked and sintered integral at one temperature. Control 3 is a substrate formed by the conventional method shown in FIGS. 8A and 8B, in which holes are formed in the layers of the respective green sheets forming a multi-layer structure, and different materials are buried in the holes to form the passive elements in the x and the y directions of the green sheets to thereby incorporate the passive elements inside the substrate.

TABLE 1

| | Control 1 (Substrate | | | |
|---|---|---|---|---|
| | with Passive | Control 2 | Control 3 | |
| | Functions not | (Forming Method | (Forming Method | |
| | Incorporated) | in FIGs. 7A-7B) | in FIGs. 8A-8B) | Example |
| Size of Module | 30 × 30 × 4 | 20 × 20 × 4 | 10 × 10 × 2 | 7 × 7 × 2 |
| (mm) | | | | |
| Required Layer | 10 | 8 | 5 | 5 |
| Number | | | | |
| Module Surface | 55 | 20 | 15 | 10 |
| Mounted Passive | | | | |
| Element Number | | | | |
| Passive Element | Reliable | Not Reliable | Reliable | Reliable |
| Mounted | (Soldered) | (Easy Inter- | | |
| Reliability | | layer Release) | | |
| Alignment | 100 | 100 | 100 | 50 |
| Precision (μm) | | | | |

As evident in TABLE 1, the alignment precision of the Controls 1 to 3 was 100 μm, but that of the Example was as high as 50 μm. Based on this result, it was confirmed that the present invention can make the inter-layer alignment of the ceramic substrate with high precision.

The numbers of the passive elements which could be incorporated inside the substrate by the Controls 2 and 3 were 35 and 40 respectively, but the number of the passive elements which could be incorporated inside the substrate by the Example of the present invention was 45, which was more than the numbers of the Controls 2 and 3. Based on this result, it was confirmed that the present invention can incorporate many passive elements inside the ceramic substrate.

[Modified Embodiments]

The present invention is not limited to the above-described embodiment and can cover other various modifications.

For example, in the above-described embodiment, the ceramic substrate of four-layer structure is described. However, the number of the layer of ceramic substrate to be formed is not limited to four layers and can be changed suitably as required.

The materials of the high dielectric layers, the stress mitigating layers, the base dielectric layers are not limited to those described in the above-described embodiment and can be various dielectric materials as long as they can be printed by screen printing. The materials of the base dielectric layers burying the vias, the high dielectric layers and the stress mitigating layers are paste. However, it is also possible that the base dielectric layers are formed of powder dielectric materials to bury the vias, the high dielectric layers and the stress mitigating layers.

In the above-described embodiment, the material of the vias and conductor layers is Ag paste, but Ag paste is not essential. Various conductor pastes can be used as the materials of the vias and the conductor layers as long as they are can be printed by screen printing.

In the above-described embodiment, one stress mitigating layer is formed between the high dielectric layer and the base dielectric layer, but one layer is not essential. A plurality of the stress mitigating layers may be formed, and in this case, preferably the material compositions of a plurality of the stress mitigating layers are graded. That is, it is preferable that a plurality of the stress mitigating layers have material compositions which are nearer to a composition of the high dielectric layer as the layers are nearer to the high dielectric layer and are nearer to a composition of the base dielectric layer as the layers are nearer to the base dielectric layer.

In the above-described embodiment, the respective materials are printed by screen printing on a resin film on the substrate as the printing base. However, the base to be printed is not essentially the resin film, and various bases can be printed.

In the above-described embodiment, the high dielectric layers of the respective layers of the ceramic substrate are formed of the same materials by screen printing. However, a material of the high dielectric layer of a prescribed layer can be different from a material of the high dielectric layers of the other layers so that the former has a dielectric constant different from a dielectric constant of the other high dielectric layers.

Also in one layer, different materials are printed respectively by screen printing to thereby form the high dielectric layers of dielectric constants different in the one layer.

In the above-described embodiment, the via, the high dielectric layer, the stress mitigating layer and the base dielectric layer are formed in the stated order but may not be formed essentially in the stated order. For example, the high dielectric layer may be formed before the via is formed.

What is claimed is:

1. A method for fabricating a ceramic substrate comprising the steps of:
forming a basic layer by screen-printing a first dielectric material in a first region of a base and screen-printing a second dielectric material of a dielectric constant different from a dielectric constant of the first dielectric material in a second region of the base, the basic layer including a first dielectric layer of the first dielectric material and a second dielectric layer of the second dielectric material;
releasing the basic layer from the base; and
sintering the basic layer released from the base.

2. The method for fabricating a ceramic substrate according to claim 1, wherein
the step of forming the basic layer on the base is repeatedly performed to sequentially form on the base a plurality of the basic layers including the first dielectric layer and the second dielectric layer.

3. The method for fabricating a ceramic substrate according to claim 2, wherein
the first dielectric layer of at least one of the basic layers of a plurality of the basic layers has a dielectric constant different from a dielectric constant of the first dielectric layers of the other basic layers.

4. The method for fabricating a ceramic substrate according to claim 1, wherein
the step of forming the basic layer further includes the step of screen-printing a third dielectric material in a third region of the base at a periphery of the first region to form a third dielectric layer for mitigating stress generated between the first dielectric layer and the second dielectric layer.

5. The method for fabricating a ceramic substrate according to claim 2, wherein
the step of forming the basic layer further includes screen-printing a third dielectric material in a third region of the base at a periphery of the first region to form a third dielectric layer for mitigating stress generated between the first dielectric layer and the second dielectric layer.

6. The method for fabricating a ceramic substrate according to claim 4, wherein
the third dielectric material has a material composition which is middle between a material composition of the first dielectric material and a material composition of the second dielectric material.

7. The method for fabricating a ceramic substrate according to claim 5, wherein
the third dielectric material has a material composition which is middle between a material composition of the first dielectric material and a material composition of the second dielectric material.

8. The method for fabricating a ceramic substrate according to claim 1, wherein
in the step of forming the basic layer, a conductor paste is screen-printed in a fourth region of the substrate to form a via.

9. The method for fabricating a ceramic substrate according to claim 2, wherein
in the step of forming the basic layer, a conductor paste is screen-printed in a fourth region of the substrate to form a via.

10. The method for fabricating a ceramic substrate according to claim 8, wherein
in the step of forming the basic layer, the via is formed in pole.

11. The method for fabricating a ceramic substrate according to claim 9, wherein
in the step of forming the basic layer, the via is formed in pole.

12. The method for fabricating a ceramic substrate according to claim 1, further comprising, after the step of forming the basic layer, the step of
screen-printing a conductor paste on the basic layer to form a conductor layer.

13. The method for fabricating a ceramic substrate according to claim 2, further comprising, after the step of forming the basic layer, the step of
screen-printing a conductor paste on the basic layer to form a conductor layer.

14. The method for fabricating a ceramic substrate according to claim 12, further comprising, after the step of forming the conductor layer, the step of
pressurizing the basic layer including the first dielectric layer the second dielectric layer at the surface where the conductor layer is formed to planarize the surface of the basic layer, where the conductor layer is formed.

15. The method for fabricating a ceramic substrate according to claim 13, further comprising, after the step of forming the conductor layer, the step of
pressurizing the basic layer including the first dielectric layer the second dielectric layer at the surface where the conductor layer is formed to planarize the surface of the basic layer, where the conductor layer is formed.

16. The method for fabricating a ceramic substrate according to claim 12, wherein
a circuit formed of the first dielectric layer and the conductor layer has at least two functions of a transmission interconnection circuit, antenna, a low-pass filter, a high-pass filter, a band-pass filter and a capacitor.

17. The method for fabricating a ceramic substrate according to claim 13, wherein
a circuit formed of the first dielectric layer and the conductor layer has at least two functions of a transmission interconnection circuit, antenna, a low-pass filter, a high-pass filter, a band-pass filter and a capacitor.

18. The method for fabricating a ceramic substrate according to claim 1, wherein
in the step of forming the basic layer, the second dielectric material in powder or paste is screen-printed to bury the first dielectric layer in the second dielectric layer.

19. The method for fabricating a ceramic substrate according to claim 2, wherein
in the step of forming the basic layer, the second dielectric material in powder or paste is screen-printed to bury the first dielectric layer in the second dielectric layer.

20. The method for fabricating a ceramic substrate according to claim 1, further comprising the step of
forming the conductor layers on and below the first dielectric layer to form a passive element in the region where the first dielectric layer is formed.
